(19) United States
(12) Patent Application Publication
(10) Pub. No.: US 2018/0268336 A1
(43) Pub. Date: Sep. 20, 2018

(54) Generating Construction Metrics Using Probabilistic Methods

(71) Applicant: Katerra, Inc., Menlo Park, CA (US)

(72) Inventors: Patrick Tierney, San Francisco, CA (US); Abhijit Oak, Orinda, CA (US)

(21) Appl. No.: 15/821,030

(22) Filed: Nov. 22, 2017

Related U.S. Application Data
(60) Provisional application No. 62/471,544, filed on Mar. 15, 2017.

(51) Int. Cl. G06Q 10/06; G06N 7/00

(52) U.S. Cl. CPC G06Q 10/06313; G06N 7/005

(57) ABSTRACT

A system obtains a variance in a probability distribution of a building construction process metric. The system selects one or more of the plurality of random variables on which the building construction process metric is a dependent random variable, assigns a value to each selected random variable, obtains from a database that stores probability distributions for the plurality of random variables a probability distribution for each selected random variable, and determines a variance in the probability distribution for the building construction process metric based on a calculation involving the assigned value, and the obtained probability distribution, for each selected random variable. When the determined variance exceeds a maximum target variance, the system adjusts the value assigned to at least one of the selected random variables and/or select a new one or more of the plurality of random variables on which the building construction process metric is a dependent random variable and repeats the process.

### RELATED APPLICATIONS

This application claims the benefit of the filing date of U.S. provisional patent application No. 62/471,544, filed Mar. 15, 2017, entitled “Generating Construction Metrics Using Probabilistic Methods”, the entire contents of which are incorporated by reference under 37 C.F.R. § 1.57.

### TECHNICAL FIELD

Embodiments of the present invention relate to system for obtaining a maximum target variance in a probability distribution of a building construction process metric, such as cost of, or timeline for, a building construction process.

### BACKGROUND

In the prior art, construction metrics estimates are not modeled as stochastic variables. Instead construction metrics estimates, for example, estimates of project cost and project timeline are quoted as fixed numbers. In reality, the construction process of a building, as well as the site selection process and other associated processes, is not a deterministic process. Consider some of the elements in the time model for a construction process, and their dependence on random variables:
1. Procurement time—the procurement time for a building element is a variable that has a random distribution depending on such factors as the availability of the building element, the lead time to procure the part at a particular period of time, the number of building elements being procured, the number of alternative supply sources, etc.
2. Construction time—the construction time for a building process is a variable that has a random distribution depending on such factors as weather conditions, availability of shared resources, availability and quality of labor, scheduling of interdependent construction activities, etc.
3. Delivery time—the transportation of building elements from the supply source to the construction site is a variable that has a random distribution depending on such factors as weather conditions, traffic conditions, etc.
4. Failures during transportation or installation of a building element—a building element may be damaged in transportation or during installation. These failures are, of course random in nature.

Representing a random process with a fixed number can result in a number of undesirable scenarios. Perhaps the most common is a building project comes in over budget and finishes late. Alternatively, a general contractor can lose the bid by being overly conservative.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 illustrates a visual depiction of probabilities that may be merged with a Monte Carlo simulation method to produce a compound probability, in accordance with an embodiment of the invention.

FIG. 2 is a flow diagram of an embodiment of the invention.

FIG. 3 is a flow diagram of an embodiment of the invention.

FIG. 4 is a flow diagram of an embodiment of the invention.

FIG. 5 illustrates a diagrammatic representation of a machine in the exemplary form of a computer system, in accordance with one embodiment of the invention.

### DETAILED DESCRIPTION

Embodiments of invention involve probabilistically modeling a building construction project as a random process. Construction metrics are calculated using stochastic variables based on a random process, with confidence limits. One embodiment of the invention provides feedback to a user of the model on how the variance in the probability distribution of the construction metrics can changed, e.g., reduced. In so doing, the user of the model can improve the building construction project, for example, improve the predictability of the project and steer the mean of the distribution to a target objective for the project.

In one embodiment, consider that the construction process is a random process and that any variable that is function of this process must therefore be a stochastic variable. Mathematically, this may be represented as:

X(y1, y2, y3, y4, . . . yₙ)
Where X is a dependent random variable and y1, y2, y3, y4 . . . yₙ are independent random variables.

For example, time to completion (TTC) for a building project may be the sum of the time of the individual tasks that make up the building project: TTC=T1+T2+T3+T4+ . . . +Tₙ. There are many ways to implement random variable calculations. Generally, an implementation comprises: (1) a database of the probability distributions for each independent random variable and (2) a calculating system that establishes the mathematical relationship between the independent random variables and the dependent quantity of interest.

On embodiment of the invention links an Enterprise Resource Planning (ERP) system containing probabilities of manufacturing times and costs, installation times and costs, and other building materials information, into a combined estimate for a construction project. In one embodiment, building metrics include probabilities, for example, on-target probabilities, based on the target value design (TVD) concept. TVD offers the potential to ensure that owners get what they pay for in a building project. Rather than designing first and estimating later, a TVD process sets a project's estimated cost as the starting point. Targets are then established for all relevant components (e.g., building envelope, structural system, interior finishes, mechanical, electrical and plumbing systems, etc.), and then targets may be adjusted up or down as the design evolves. Cost is one component of TVD. The TVD process also sets and designs toward other owner established targets such as sustainability, staffing, square footage, operations and lifecycle costs. As the TVD process progresses, various options and their effect on other parts of the project are continually considered within the context of the overall project.

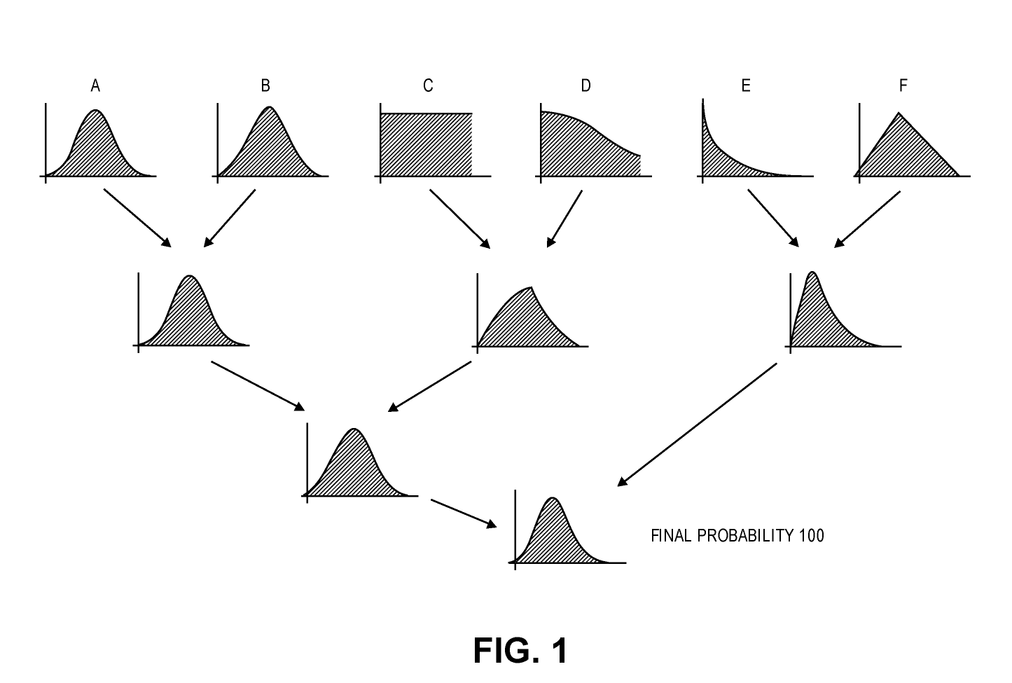

In one embodiment, these metrics are generated automatically by software, rather than metrics derived by tracking exactly what building elements were purchased and when a building project was completed. In one embodiment, the ERP system is extended to include range values, instead of static values that everybody agrees to, associated with building elements and tasks for the building project. In another embodiment, compounding probability ranges may be applied in the ERP system with generative design rules. Generative design rules can be chained together, for example, a generative design rule regarding a particular bathroom layout can be chained together with a generative design rule for a bath tub, which in turn can be chained to a generative design rule for a bath tub faucet. In such an example, the probability ranges for metrics relating to the bathroom, the bath tub, and the faucet, are combined to create a compounded probability range. In one embodiment, this involves extracting non-standard fields (e.g., probabilities not found in the ERP system) from a configured ERP system describing probabilities of both building products and work tasks. These probabilities may then be merged with a Monte Carlo simulation method to produce a compound probability 100, visually depicted in the diagram in FIG. 1. Additionally, in one embodiment, the generative design rules can be combined together not only across nested objects in a Bill of Material, but across the lifecycle of a product. For example, the probability of manufacturing of a faucet is combined with the probability of transporting the faucet, which, in turn, is combined with the probability of installing the faucet.

Embodiments of the invention solve the problem of creating Architecture, Engineering, Construction (AEC) metrics (such as cost, time to complete) when the precise input variables are not known. According to embodiments of the invention, a method for evaluating options is provided, which allows for the ability to create construction metrics when the input values are not fully known, and the ability to view metrics probabilistically, with confidence values. For example, one option might be the use of bolts in installing a building element, while another option might be welding the building element as part of the installation task. One option might be more expensive, and the estimated cost of such has a narrower probability range with broader confidence values, while the other option may be less expensive and the estimated cost of such has a larger probability range with narrow confidence values.

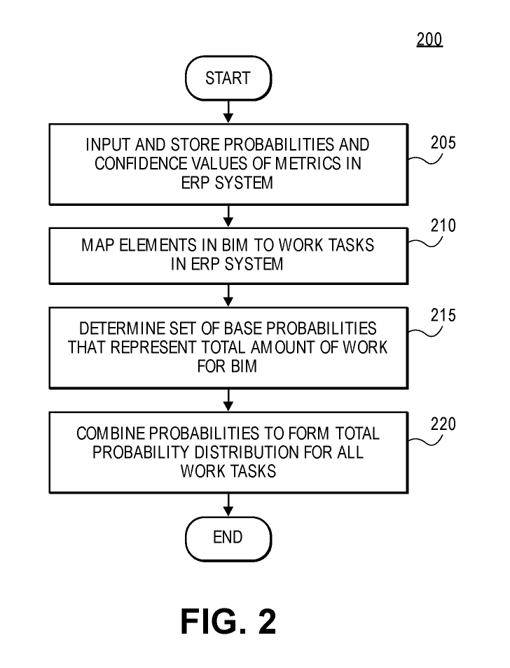

In particular, with reference to FIG. 2, an embodiment of the invention 200 captures probabilities and confidence values of metrics, such as costs and times, in an ERP system at 205, maps elements in a Building Information Model (BIM) to specific work tasks contained in an ERP system at 210, determines a set of base probabilities which represent the total amount of work for the BIM at 215, and combines the probabilities to form a total probability distribution for the entire set of work tasks at 220. In this regard, embodiments of the invention are novel in providing 1) a means to store ranges and confidence values inside of an ERP system, 2) an ability to extract range and confidence values from an ERP system, 3) an ability to map a BIM to specific work tasks contained in an ERP system, and 4) means for generating compound event probabilities from a BIM.

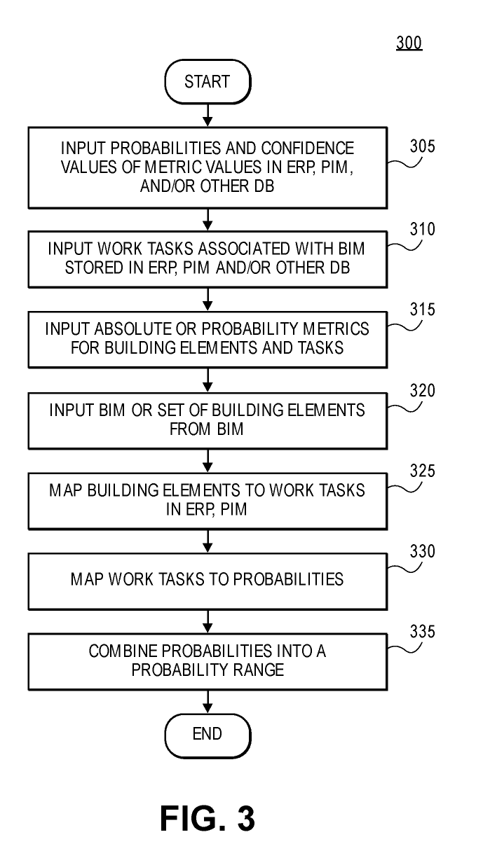

With reference to FIG. 3, one embodiment 300 captures the probabilities and confidence values of metric values for building elements and tasks, such as prices, times, and other core metrics values (e.g., sustainability, constructability, etc.), in one or a combination of Enterprise Resource Planning (ERP) database, Product Information Management (PIM) database, or another ancillary database, at 305. The embodiments then capture the specific “work” tasks associated with the BIM for storage in a combination of the ERP, PIM, and/or other databases at 310. These work tasks, in one embodiment, are numerical descriptions associated with generative design rules or static geometry for building elements, about what tasks must be associated with the geometry. For example, the square-cut edge of wooden 2″×4″ studs in a wall panel are associated with a “cutting” work task. Note that some work tasks are determined by manufacturing the item off-site, such as cutting on a Computer Numerical Control (CNC) machine. Other tasks are determined by transporting a building element to a job or building site. Other tasks are determined by on-site installation of building elements, such as manually cutting a building element with a rotary saw. Embodiments of the invention store these work tasks—manufacturing, transportation, and installation—in the ERP, PIM and/or other databased, and access the information in the BIM to determine which tasks to use.

The embodiment next captures absolute or probability metrics values associated with the building elements themselves (as opposed to the work tasks used throughout the building process) at 315. For pricing metrics, this information includes the purchased/procurement price of the building element. For timing metrics, this information includes the time of procurement/purchasing. For energy use, this information includes the embodied carbon of the building element, e.g., the carbon required to create the building element before it arrives at an off-site manufacturing plant, construction site, or the specified thermal value (u-value) supplied by the manufacturer.

Next, at 320, according to an embodiment, the process provides a BIM or set of BIM building elements as input to the system. For each BIM and/or BIM building elements, the embodiment then maps at 325 the building elements to specific work tasks in the ERP and/or PIM databases. For example, if a set of 2″×4″ wall studs are input into the system, the wall studs are associated with a “cutting” work task stored in the databases. In one embodiment, the mapping of building elements to specific work tasks involves generating and populating an Task Information Model (TIM). The decision about whether to associate tasks as off-site manufactured tasks, or on site installation site is determined by analyzing the BIM building element geometry and/or parameters.

According to an embodiment, work tasks generated from the BIM and/or the BIM elements are then mapped at 330 to the probabilities stored in the ERP and/or PIM databases. Next, at 335, the probabilities of the work tasks are combined into a single probability range. The mechanism to “flatten” these probabilities can use various methods. In one embodiment, the Monte Carlo Simulation method is used. A single, aggregate number may be represented, such as the mean or medium, rather than displaying the information as a graph.

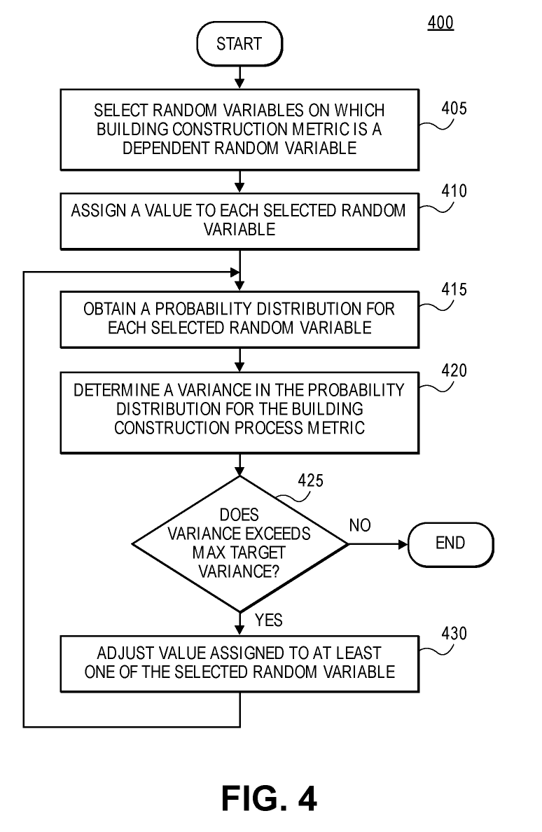

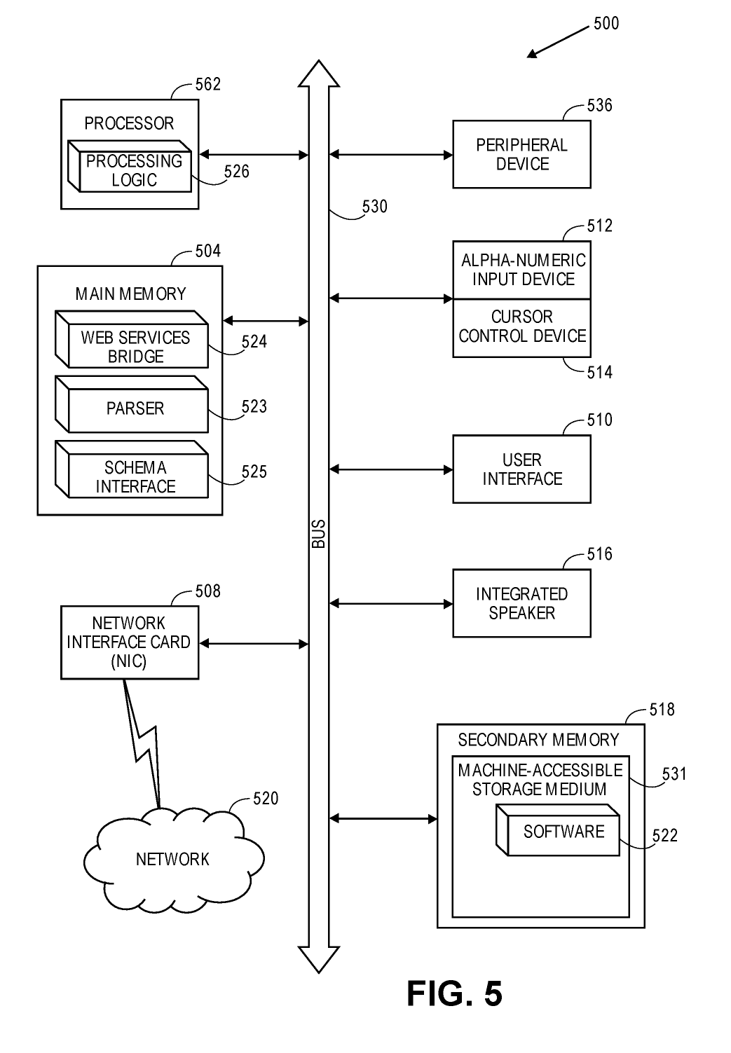

With reference to FIGS. 4 and 5 an embodiment of the invention includes a method 400 executed by a computer system for obtaining a variance, e.g., a maximum target variance, in a probability distribution of a building construction process metric. Metrics include such things as the cost of or timeline for a building construction process.

In one embodiment, a processor 562 executes software instructions 522 to perform the method 400. A storage device 531 accessible by the processor stores a database, and the database, in one embodiment, stores therein information regarding a building products information model (PIM), the PIM comprising a number of building products that are available for installation and/or meet certain criteria for inclusion in the building project. The database further stores therein a building information model (BIM) for the building project, the BIM comprising another number of building products that may be available for installation and/or may meet certain criteria for inclusion in the building project. A BIM in one embodiment is a digital representation of a 3D-based model of and corresponding process for a facility. The BIM gives architecture, engineering, and construction (AEC) professionals insight and tools to plan, design, construct, and manage the physical and functional characteristics of the facility, whether a building, an infrastructure project, or a place.

Building information modeling (BIM) involves representing a design as one or more combinations of objects, which may be vague and undefined, generic or product-specific, solid shapes, or void-space oriented (like the shape of a room), that include their geometry, relations and attributes. BIM-based design tools allow creating different views for a building project for drawing production and other uses. These different views are automatically consistent, being based on a single definition of each object instance. BIM based software may also defines objects parametrically. That is, the objects are defined as parameters and relations to other objects, so that if a related object is amended, dependent ones will automatically also change. Each BIM object can include attributes for selecting and ordering them automatically, providing cost estimates, and for material tracking and ordering, among other attributes.

The database further stores therein probability distributions for any number of random variables corresponding to building process elements. A building process element may, for example, include a building element cost, a building element availability and lead time, a building element manufacturing cost, a building element manufacturing time, a building element installation cost, a building element installation time, building element transportation cost, building element transportation time, building element sustainability, building element reliability, building element structural loading capacity.

In one embodiment, software instructions 522 executed by the processor 562 cause the system at 405 to select one or more of the random variables (y1, y2, . . . yₙ) on which the building construction process metric (X) is a dependent random variable (X (y1, y2, . . . yₙ)). In other words, the embodiment causes the system to select one or more random variables, and the construction process metric is a function of the selected one or more random variables. In one embodiment, a user interface (UI) 510 receives input from a user that the system uses to select the one or more random variables. In another embodiment, the system automatically selects by software the one or more random variables. At 410, software automatically assigns a value range to each selected random variable. In another embodiment, the UI 510 receives input from a user to assign the value range to a selected random variable.

The software instructions then cause the system to obtain from the database that stores probability distributions for the random variables a probability distribution for each selected random variable, at 415. In one embodiment, the probability distribution is based on its assigned value range.

At 420, the software instructions cause the system to determine a variance in the probability distribution for the building construction process metric based on a calculation involving the assigned value, and the obtained probability distribution, for each selected random variable. For example, the system determines a variance in probability distribution for time to completion (TTC) based on the calculation TTC=T1+T2+T3+T4.

In one embodiment, the system checks whether the variance exceeds the maximum target value, at 425. When the determined variance does in fact exceed the maximum target variance, the software instructions cause the system to adjust the value assigned to at least one of the selected random variables and/or select a new one or more of the plurality of random variables on which the building construction process metric is a dependent random variable, at 430, and then repeat the process described above, beginning at 415: obtain a new probability distribution for each newly selected random variable (e.g., based on its adjusted assigned value), and determine a new variance in the probability distribution for the construction process metric based on a new calculation involving the adjusted assigned value, and the obtained new probability distribution, for each newly selected random variable based on its adjusted assigned value. The embodiment continues in this manner until the system determines a variance in the probability distribution for the construction process metric that does not exceed the maximum target variance.

FIG. 5 illustrates a diagrammatic representation of a machine 500 in the exemplary form of a computer system, in accordance with one embodiment, within which a set of instructions, for causing the machine/computer system 500 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and a persistent database), which communicate with each other via a bus 530. Main memory 504 includes a web services bridge 524 and a schema interface 525 and a parser 523 by which to communicate with another web services environment, retrieve, and parse a schema to identify methods provided by the web service at the other web services environment in accordance with described embodiments. Main memory 504 and its sub-elements are operable in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality which is discussed herein.

The computer system 500 may further include a network interface card 508. The computer system 500 also may include a user interface 510 (such as a video display unit, a liquid crystal display, etc.), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc.).

The secondary memory 518 may include a non-transitory machine-readable storage medium or a non-transitory computer readable storage medium or a non-transitory machine-accessible storage medium 518 on which is stored one or more sets of instructions (e.g., software 822) embodying any one or more of the methodologies or functions described herein. The software 822 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. A system for obtaining a variance in a probability distribution of a building construction process metric, comprising:
a processor to execute software instructions;
a storage device in communication with the processor in which to store a database, the database to store therein probability distributions for a plurality of random variables corresponding to building process elements;
a user interface (UI) via which to receive input and transmit output according to software instructions executed by the processor; and
software instructions that when executed by the processor, cause the system to:
select one or more of the plurality of random variables on which the building construction process metric is a dependent random variable;
assign a value to each selected random variable;
obtain from the database that stores probability distributions for the plurality of random variables a probability distribution for each selected random variable;
determine a variance in the probability distribution for the building construction process metric based on a calculation involving the assigned value, and the obtained probability distribution, for each selected random variable;
when the determined variance exceeds a maximum target variance:
adjust the value assigned to at least one of the selected random variables and/or select a new one or more of the plurality of random variables on which the building construction process metric is a dependent random variable;
obtain a new probability distribution for each newly selected random variable; and
determine a new variance in the probability distribution for the construction process metric based on a new calculation involving the adjusted assigned value, and the obtained new probability distribution, for each newly selected random variable.

2. The system of claim 1, wherein the building construction process metric is a cost of, or timeline for, a building construction process.

3. The system of claim 1, wherein the probability distributions for a plurality of random variables corresponding to building process elements is selected from a group consisting of as a building element cost, a building element availability, and building element supply lead time, a building element manufacturing cost, a building element manufacturing time, a building element installation cost, a building element installation time, a building element transportation cost, a building element transportation time, a building element sustainability, a building element reliability, and a building element structural loading capacity.

4. The system of claim 1, wherein the construction process metric is a function of the selected one or more random variables.

5. The system of claim 1, wherein the value assigned to each selected random variable is assigned automatically by the software instructions.

6. The system of claim 1, wherein the value assigned to each selected random variable is assigned manually via user input.

7. The system of claim 1, wherein the software instructions that when executed by he processor cause the system to obtain a new probability distribution for each newly selected random variable includes the software instructions that when executed by the processor cause the system to obtain a new probability distribution for each newly selected random variable based on its adjusted assigned value.

8. The system of claim 7, wherein the software instructions that executed by the processor cause the system determine the new variance in the probability distribution for the construction process metric based on the new calculation involving the adjusted assigned value, and the obtained new probability distribution, for each newly selected random variable includes software instructions that when executed by the processor cause the system determine the new variance in the probability distribution for the construction process metric based on the new calculation involving the adjusted assigned value, and the obtained new probability distribution, for each newly selected random variable based on its adjusted assigned value.

9. A method performed by a system having at least a processor and a memory therein, comprising, comprising:
selecting one or more of a plurality of random variables on which a building construction process metric is a dependent random variable;
assigning a value to each selected random variable;
obtaining from a database that stores probability distributions for the plurality of random variables a probability distribution for each selected random variable;
determining a variance in the probability distribution for the building construction process metric based on a calculation involving the assigned value, and the obtained probability distribution, for each selected random variable;
when the determined variance exceeds a maximum target variance:
adjusting the value assigned to at least one of the selected random variables or selecting a new one or more of the plurality of random variables on which the building construction process metric is a dependent random variable;
obtaining a new probability distribution for each newly selected random variable; and
determining a new variance in the probability distribution for the construction process metric based on a new calculation involving the adjusted assigned value, and the obtained new probability distribution, for each newly selected random variable.

10. Non-transitory computer readable storage media having instructions stored thereon that, when executed by a processor of a system, cause the system to perform operations including:
selecting one or more of a plurality of random variables on which a building construction process metric is a dependent random variable;
assigning a value to each selected random variable;
obtaining from a database that stores probability distributions for the plurality of random variables a probability distribution for each selected random variable;
determining a variance in the probability distribution for the building construction process metric based on a calculation involving the assigned value, and the obtained probability distribution, for each selected random variable;
when the determined variance exceeds a maximum target variance:
adjusting the value assigned to at least one of the selected random variables or selecting a new one or more of the plurality of random variables on which the building construction process metric is a dependent random variable;
obtaining a new probability distribution for each newly selected random variable; and
determining a new variance in the probability distribution for the construction process metric based on a new calculation involving the adjusted assigned value, and the obtained new probability distribution, for each newly selected random variable.
